(19) United States
(12) Patent Application Publication
(10) Pub. No.: US 2025/0333013 A1
(43) Pub. Date: Oct. 30, 2025

(54) VOICE CAPTURE, IDENTIFICATION, AND PRIVATE AUDIO PLAYBACK SYSTEM

(71) Applicant: TOYOTA BOSHOKU AMERICA, Novi, MI (US)

(72) Inventor: Nicholas Flannery, Grand Rapids, MI (US)

(73) Assignee: TOYOTA BOSHOKU AMERICA, Novi, MI (US)

(21) Appl. No.: 19/194,976

(22) Filed: Apr. 30, 2025

Related U.S. Application Data
(60) Provisional application No. 63/640,608, filed on Apr. 30, 2024.

(51) Int. Cl. B60R 16/037; B60N 2/879; B60R 11/02; H04R 1/40

(52) U.S. Cl. CPC B60R 16/0373; B60N 2/879; B60R 11/0247; H04R 1/403; H04R 2499/13

(57) ABSTRACT

An integrated sound and voice interaction system for a seat occupant is provided. The system includes speakers associated with the seat headrest. One or more microphones are provided in close proximity to the seat occupant. The speakers and associated microphones work in conjunction to generate a private localized sound bubble, a space where audio is delivered directly to the individual without leakage into the broader environment. This localized sound bubble allows for personalized media consumption and interaction with the vehicle's systems without interference by other passengers. The system includes a sophisticated voice human machine interface which recognizes and distinguishes between occupants' voices within the local area, allowing the system to deliver tailored responses and actions through the headrest's speakers. This personalized HMI response caters to the individual's commands or queries while maintaining privacy. Each occupant can interact with the vehicle's HMI to access personalized content, navigation assistance, or communication services.

### DESCRIPTION OF THE INVENTION

### Technical Field

The disclosed inventive concept relates generally to personal sound systems use by seat occupants in various modes of transportation. More particularly, the disclosed inventive concept relates to a seat arrangement having an integrated sound and voice interaction system for the seat occupant. The system includes speakers associated with the seat headrest. One or more microphones are provided in close proximity to the seat occupant. The speakers and associated microphones work in conjunction to generate a private localized sound bubble, a space where audio is delivered directly to the individual without leakage into the broader environment. This localized sound bubble allows for personalized media consumption and interaction with the vehicle's systems without interference by other passengers.

### BACKGROUND OF THE INVENTION

There is increasing interest in enhancing the in-vehicle experience for seat occupants, including both operators and passengers, in all vehicles, whether in the automotive, airline, rail, or marine industries. Central to this enhanced experience is the development of audio systems that can deliver high-quality sound tailored to the individual's preferences without disturbing other occupants. Simultaneously, there's a growing interest in advanced Human-Machine Interface (HMI) systems that can understand and respond to voice commands with high accuracy. Despite significant technological advancements, most in-vehicle audio systems still lack the ability to provide truly individualized and private listening experiences. Moreover, current voice recognition systems in vehicles often struggle with distinguishing between speakers, leading to less efficient control and interaction.

The challenge facing designers lies in difficulties associated with creating a vehicle environment where auditory output and HMI responsiveness are not only high quality but also personalized and contained within a defined space. This not only improves personal enjoyment and convenience but also mitigates distractions, thereby contributing to safer operating conditions.

The problem of providing unique and tailored audio experiences is not unique to the automotive market. For example, a solution to this problem could be used in the video game industry, in workplaces, in airplane and rail interiors, as well as many other markets. Accordingly, there remains room in the technology of vehicle audio experiences to provide improvements.

### SUMMARY OF THE INVENTION

The disclosed inventive concept presents an integrated sound and voice interaction system for use in any vehicle system having seats. The system is comprised of speakers embedded within the seat headrest to generate a private localized sound bubble, a space where audio is delivered directly to the seat occupant without significant leakage into the broader environment. This private localized sound bubble allows for personalized media consumption and interaction with the vehicle's systems without interference by passengers.

Complementing this auditory experience is a sophisticated voice Human-Machine Interface (HMI) that is capable of recognizing and distinguishing between the different occupants' voices within the vehicle. Once a specific voice is identified, the system can deliver tailored responses and actions through the headrest's speakers. This personalized HMI response caters to the individual's commands or queries while maintaining their privacy. The system's microphones may be associated with the headrest or may be located in any other position local to the occupant's seat.

The system allows each occupant to interact with the vehicle's HMI to access personalized content, navigation assistance, or communication services. For instance, a driver can receive navigation prompts without disturbing the sleep of a passenger, who could simultaneously be engaging in a private phone call or enjoying entertainment through the same headrest system.

The disclosed inventive concept sets the stage for a new standard in personalized in-vehicle audio experiences, combining private audio playback with intelligent voice recognition to offer each occupant a tailored and secluded interaction with the vehicle's systems.

Other advantages and features of the embodiments of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 is a perspective view of a seat having the integrated sound and voice interaction system according to the present invention;

FIG. 2 is a perspective rear view of the head restraint of the seat of FIG. 1 illustrating the head restraint associated with the seat;

FIG. 3 is an alternative perspective view of the head restraint of the seat of FIG. 1 illustrating the seat in isolation;

FIG. 4 is a front view of the head restraint of the seat of FIG. 1 illustrating the seat in isolation;

FIG. 5 is an internal view of speaker layout of the head restraint of FIG. 4;

FIG. 6 is a perspective view of a vehicle interior which illustrates a plurality of speakers and microphones of the integrated sound and voice interaction system according to the disclosed invention;

FIG. 7 is a plan view of a vehicle having the integrated sound and voice interaction system which includes strategically placed speakers and microphones;

FIG. 8 is an alternate plan view of the vehicle interior illustrated in FIG. 7;

FIG. 9 is a diagram illustrating the system of the present invention in which audio returned by the voice HMI systems can be processed to deliver an improved private audio signal to the user of the system;

FIG. 10 is a side view of an alternative embodiment of the disclosed invention for use in an airplane or train; and

FIG. 11 is a diagram of the system integrated into the overhead unit of an airplane seat of the type illustrated in FIG. 10.

### DETAILED DESCRIPTION OF THE PREFERRED EMBODIMENTS

In the following figures, the same reference numerals will be used to refer to the same components. In the following description, various operating parameters and components are described for one constructed embodiment. These specific parameters and components are included as examples and are not meant to be limiting.

The disclosed inventive concept having an integrated sound and voice interaction system for use in a vehicle having seats comprises five primary subsystems. These subsystems include the following.

Private Voice Interaction System: A module which contains a speaker system designed to provide a private listening experience. A private localized sound “bubble” produced by this system is only audible to the occupant or person within a specific distance from the speakers. The module also contains one or more microphones which can be used to detect the voice signal from the occupant within the private localized sound bubble.

Electronics Module and Junction: A module which transfers the signals from one sub system to another. Depending on the application, this sub-system can be installed either local or remote to the private voice interaction system.

Voice Identification System: A system capable of ingesting a microphone signal which contains the voice signal from a primary speaker. The system returns an ID flag which indicates who the primary speaker is and a transformed microphone signal which contains only the signal of the primary speaker.

Audio Processing: A system by which audio returned by the voice Human-Machine Interface (HMI) systems can be processed to deliver the best private audio signal to the user of the system.

Local or Cloud Provided Voice HMI Systems: These systems inject the processed voice signal from the speaker and returns content specific to the person's request. The location of these systems can be local or remote to the private voice interaction system.

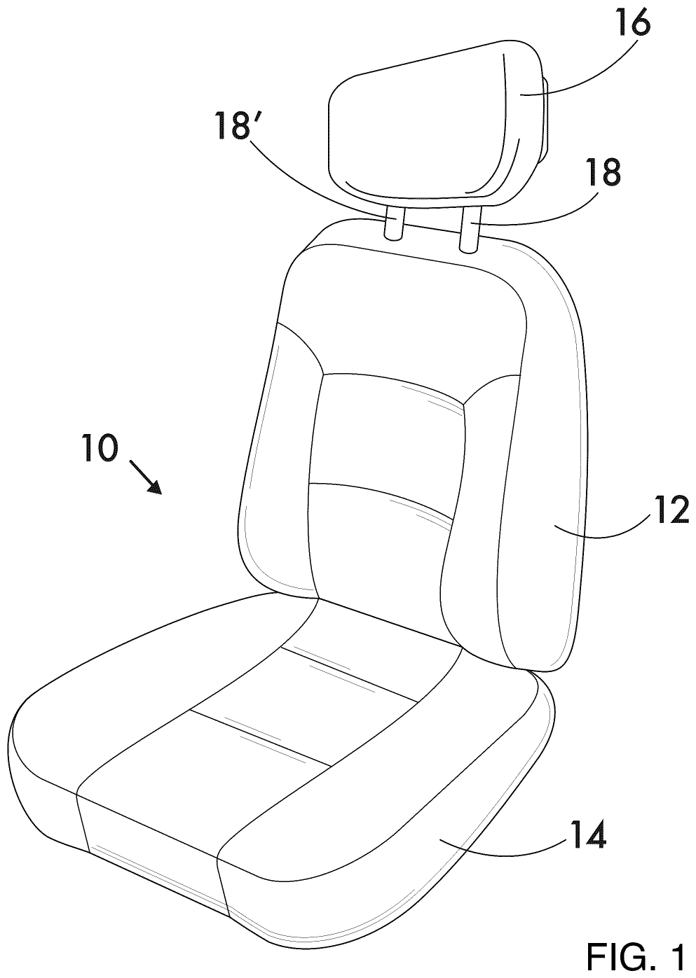

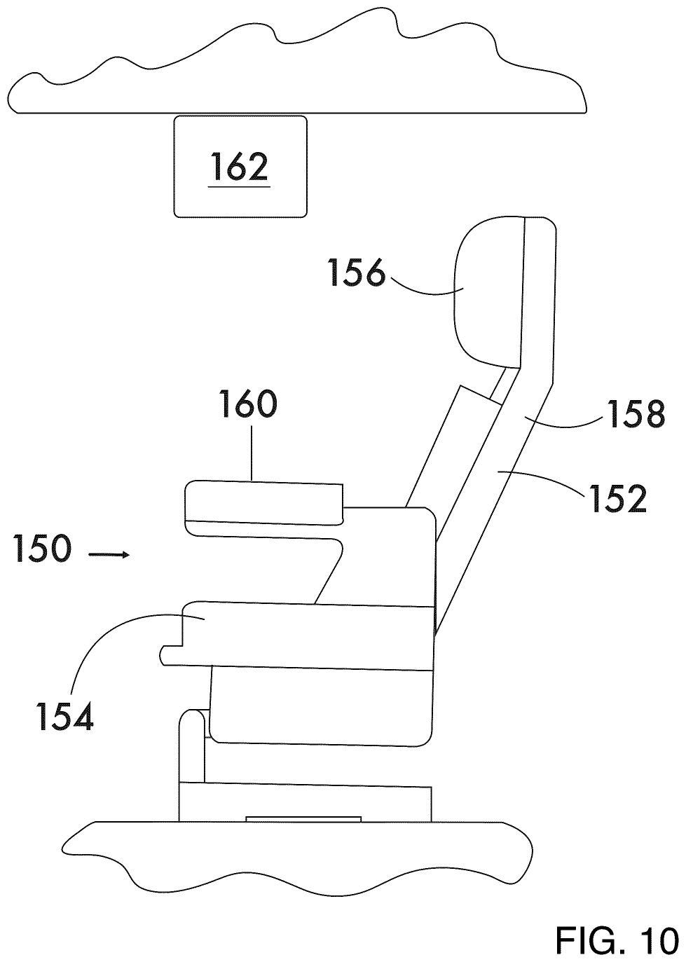

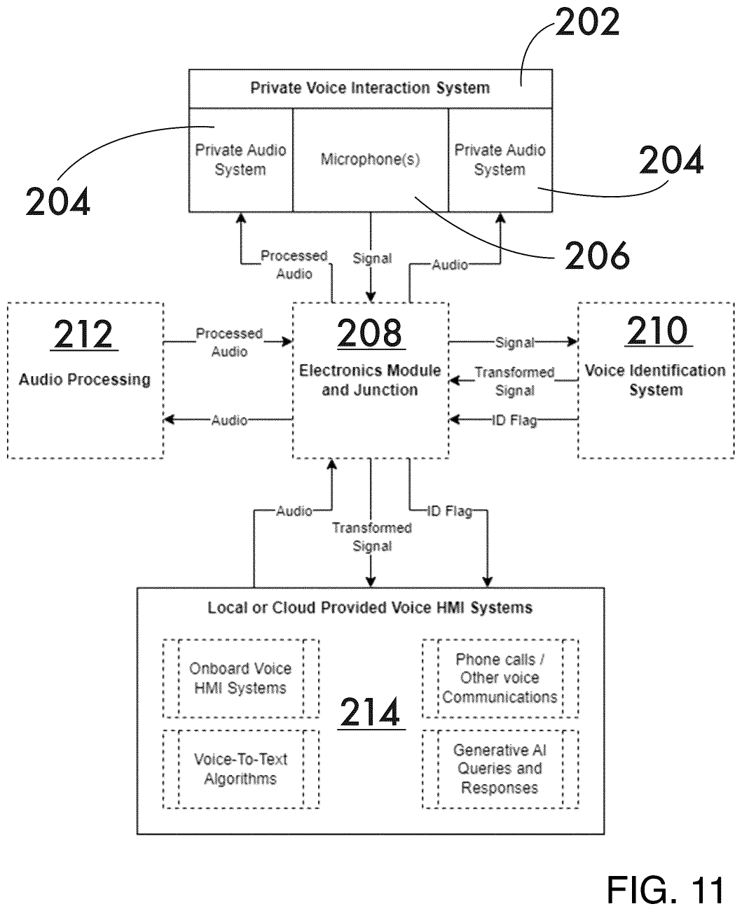

Two embodiments of the disclosed invention are provided. According to the first embodiment, the seat communication system is used primarily though not exclusively in automotive vehicles as well buses, trains, mass transit terminal seating, and in such diverse applications such as gaming systems. The first embodiment is discussed in conjunction with FIGS. 1 through 9. According to the second embodiment, the seat communication system is used primarily though not exclusively in aircraft and in similar environments where an overhead control panel is ordinarily provided. The second embodiment is discussed in conjunction with FIGS. 10 and 11.

Referring to FIG. 1, a perspective view of a seat having the integrated sound and voice interaction system according to the present invention is illustrated. A perspective view of a seat generally illustrated as 10 is shown. The seat 10 includes a seat back 12 and a seat base 14. It is to be understood that the seat 10 is shown for illustrative purposes only. The shapes and sizes of the seat back 12 and the seat base 14 as illustrated are not intended as being limiting.

The seat 10 includes a head restraint 16 attached to the seat back 12 by a pair of head restraint stays 1 and 18′. As is conventionally known, the head restraint stays 18 and 18′ allow for up and down movement of the head restraint 16 relative to the seat back 12 to provide optimum comfort for the seat occupant (not shown).

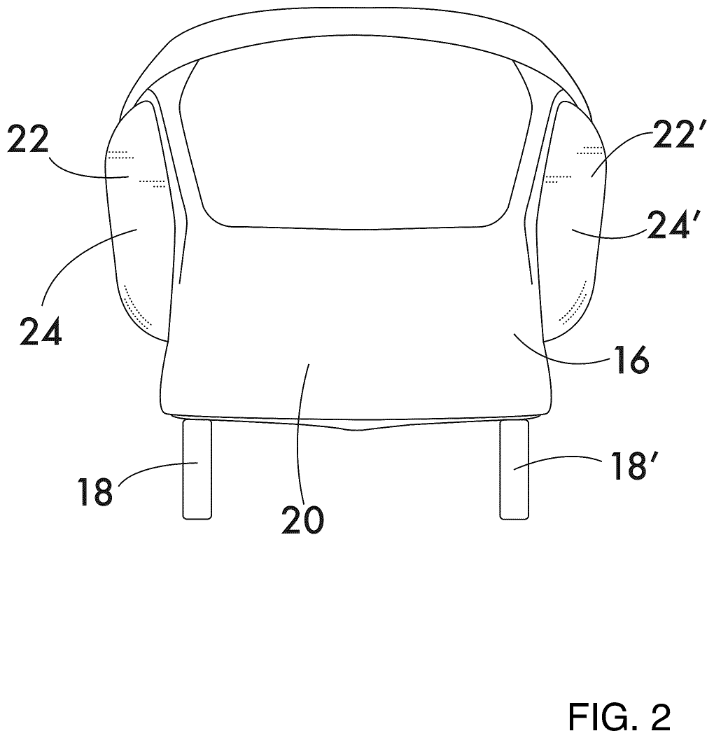

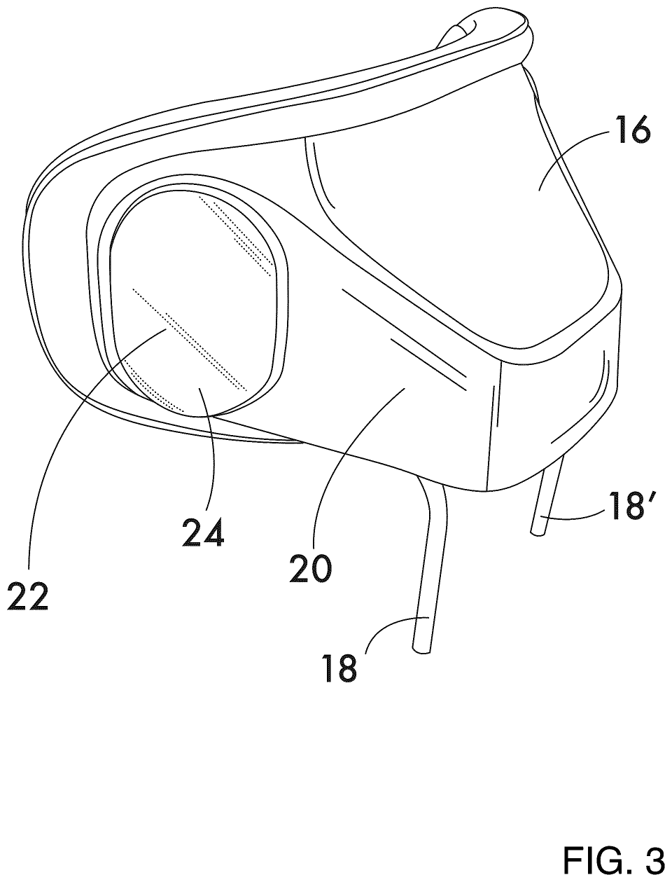

Referring to FIGS. 2 through 4, various views of the head restraint 16 according to the present invention are illustrated. The head restraint 16 includes a body 20 and at least one speaker, and preferably at least two speakers, integrally mounted within the body 20 of the head restraint 16. As illustrated in FIGS. 2 and 3, a pair of spaced-apart speaker housings 22 and 22′ are fitted to the sides of the body 20. The placement, shape, and overall appearance of the speaker housings 22 and 22′ as shown are for illustrative purposes only and are not intended as being limiting. Preferably, the speaker housings 22 and 22′ respectively include external speaker screens 24 and 24′.

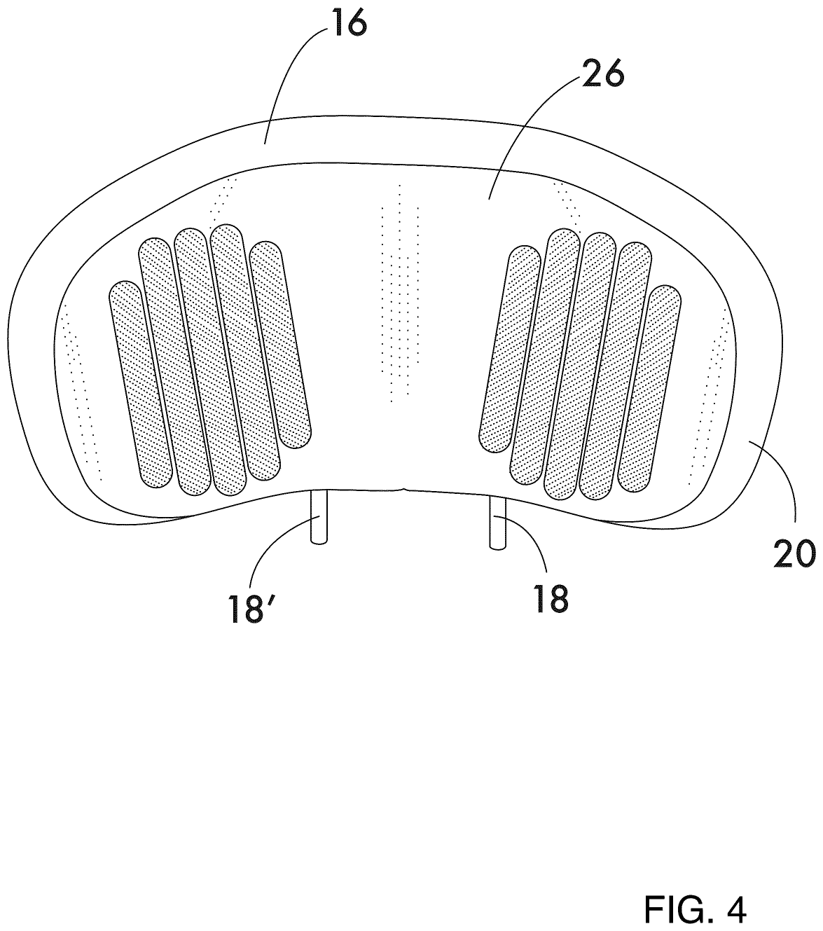

Referring to FIG. 4, a front view of the head restraint 16 is illustrated in isolation. The head restraint 16 includes a vehicle-forward facing padded cover 26 fixed to the body 20 of the head restraint 16. The shape and overall appearance of the cover 26 are for illustrative purposes and are not intended as being limiting.

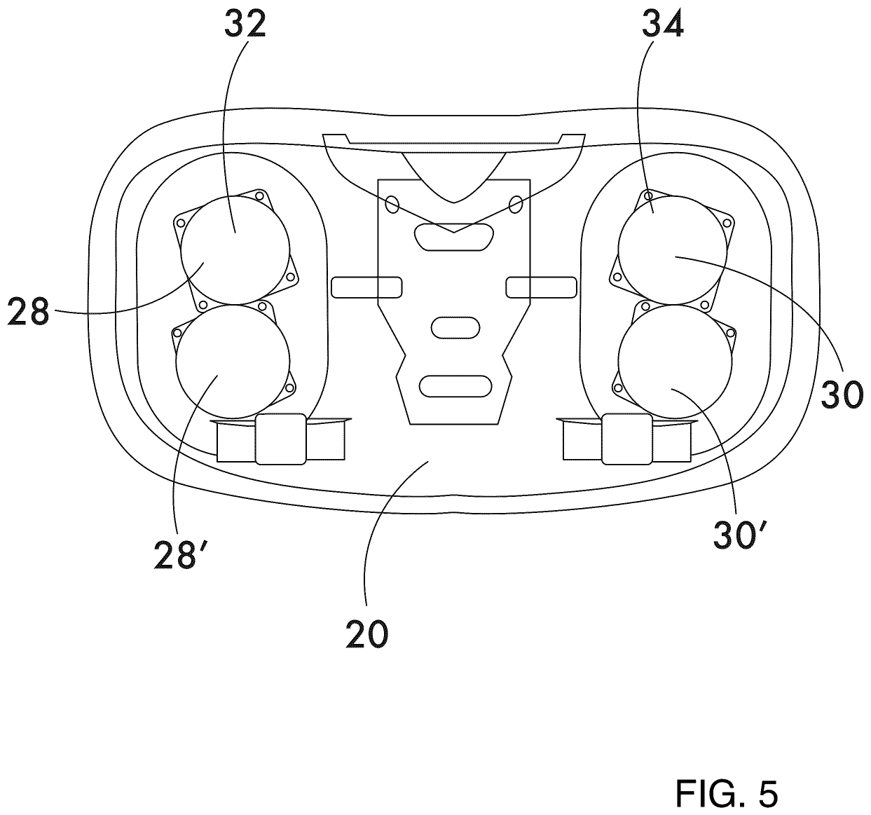

The speaker array is provided within the body 20 of the head restraint 16. The internal structure of the head restraint 16 is illustrated in part in FIG. 5. Referring to this figure, a first set of speakers 28 and 28′ is provided on one side of the body 20 while a second set of speakers 30 and 30′ is provided on the other side of the body 20. The number and placement of the speakers as illustrated is suggested but is not intended as being limiting.

The first set of speakers 28 and 28′ are fitted within a vehicle-rearward facing speaker shell 32 while the second set of speakers 30 and 30′ are fitted within a vehicle-rearward facing speaker shell 34.

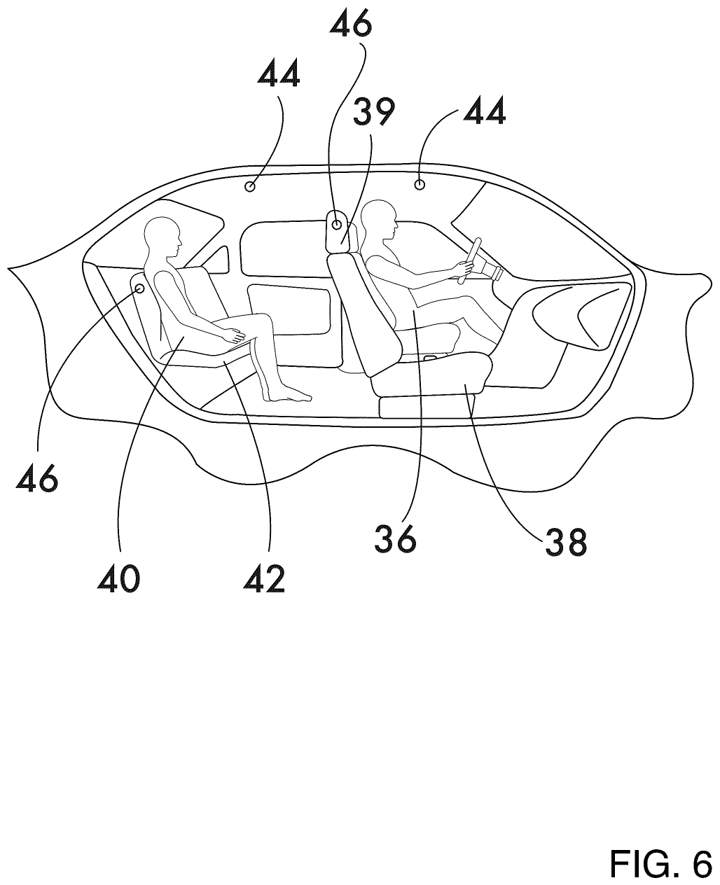

Referring to FIG. 6, a perspective view of a vehicle interior which illustrates a plurality of speakers and microphones of the integrated sound and voice interaction system according to the disclosed invention is shown. A seat occupant 36 is seated on a front seat 38 having a head restraint 39 while a seated occupant 40 is seated on rear seat 42. As shown, microphones 44 may be strategically placed in the headliner of the vehicle or may be placed on either the front seat 38 or the rear seat 42. An array of speakers 46 may be strategically placed on the head restraint 39. According to this arrangement, the front seat occupant 36 is able to communicate with the rear seat occupant without background or cabin noise interfering with their communication. In addition, or in the alternative, the microphone 44 and the head restraint speakers 46 provide the front seat occupant 36 (or any other seat occupant) with a private localized sound bubble.

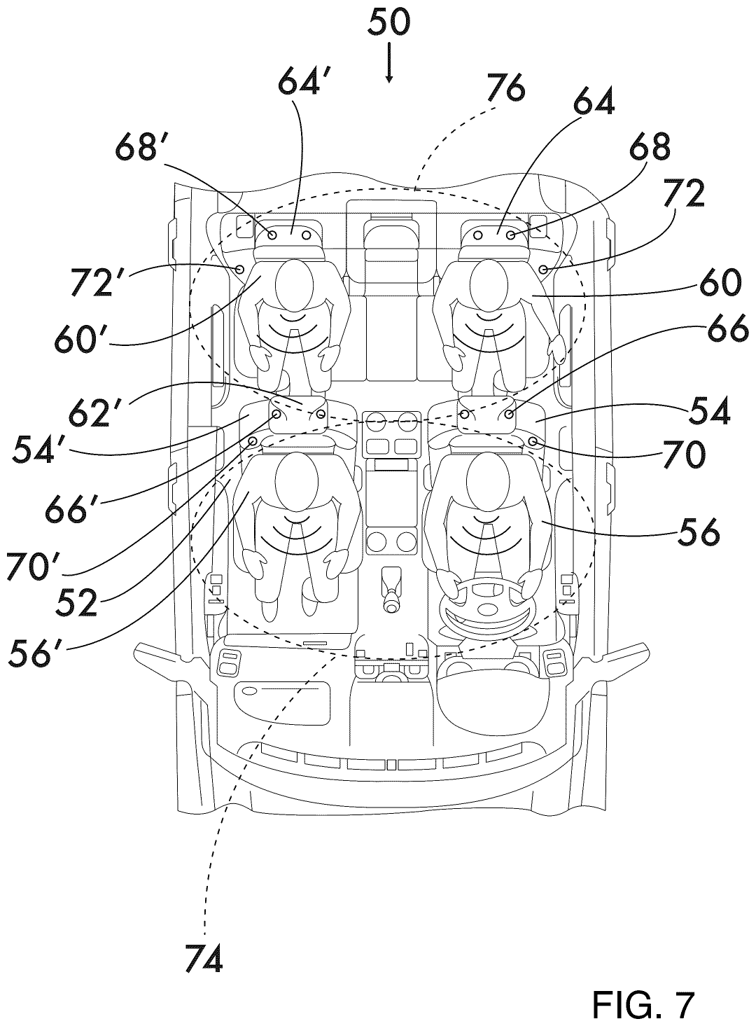

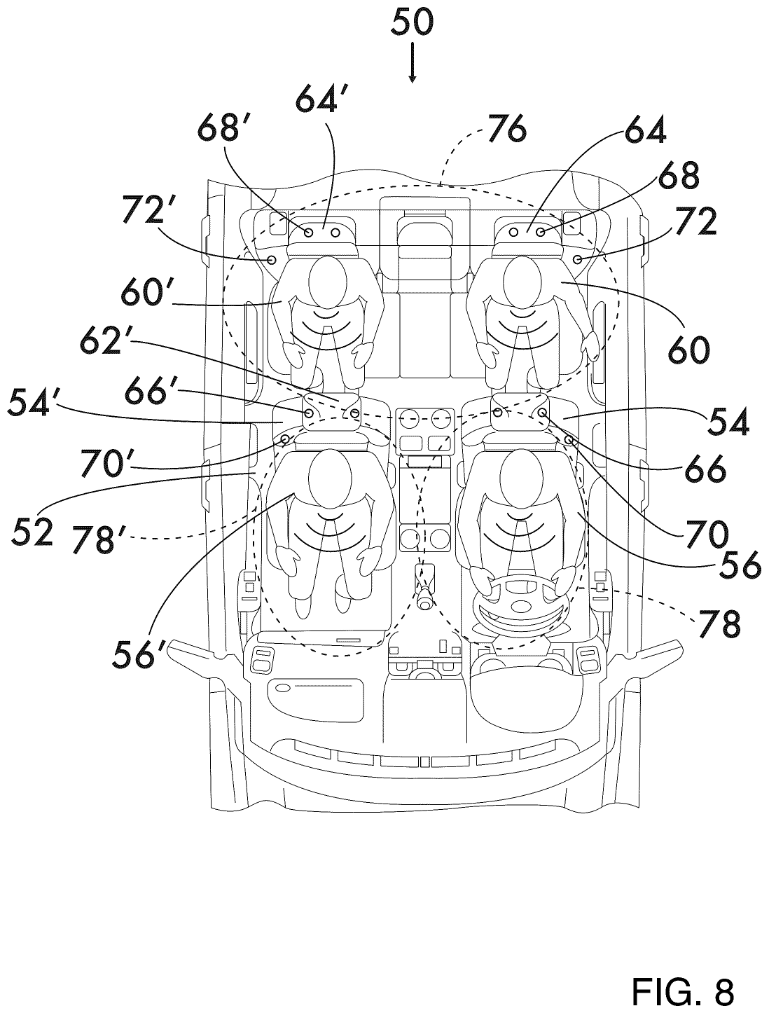

FIGS. 7 and 8 illustrate various plan views of a vehicle having the integrated sound and voice interaction system which includes strategically placed speakers and microphones according to the present invention. As illustrated in FIGS. 7 and 8, a vehicle 50 includes a cabin 52. The vehicle 50 may be of any of a variety of vehicles and is not limited to being an automotive vehicle.

The vehicle cabin 52 includes a first front seat 54 having a seat occupant 56, a second front seat 54′ having a seat occupant 56′, a rear seat 58 having a first seat occupant 60 and a second seat occupant 60′. The first front seat 54 includes a first front head restraint 62, the second front seat 54′ includes a second front head restraint 62′, and the rear seat 58 includes a first rear head restraint 64 and a second rear head restraint 64′.

The first front head restraint 62 is fitted with at least one speaker 66 and the second front head restraint 62′ is fitted with at least one speaker 66′. The first rear head restraint 64 is fitted with at least one speaker 68 and the second rear head restraint 64′ is fitted with at least one speaker 68′. The placement and number of the speakers 66, 66′, 68, and 68′ may be varied from arrangement illustrated in FIGS. 7 and 8.

The vehicle cabin 52 is also fitted with a strategically placed array of microphones. The microphones may be associated with the headliner of the vehicle as illustrated in FIG. 6 or, as an alternative or in addition, may be associated with one or more of the vehicle seats, including placement in the armrest or console or in one or more of the roof pillars. As shown, and for illustrative purposes only, each of the front seats 54 and 54′ is fitted with a front microphone 70 and 70′ respectively while the rear seat 58 is fitted with rear microphones 72 and 72′. The placement and number of the microphones 70, 70′, 72, and 72′ may be varied from arrangement illustrated in FIGS. 7 and 8.

The strategically placed array of speakers and microphones of the disclosed invention are selectively operated to private localized sound bubbles within the vehicle cabin 52. The private localized sound bubbles may be created around and individual seat occupant or around two or more seat occupants. For example, and referring to FIG. 7, a private localized sound bubble 74 is selectively created around the front seat occupant 56 and the front seat occupant 56′ while a private localized sound bubble 76 is selectively created around the rear seat occupants 60 and 60′. The private localized sound bubbles 74 and 76 provide a quiet and secure environment in which only the specific seat occupants can participate.

The private localized sound bubbles need not be limited to group conversation but can be restricted to individuals. For example, and referring to FIG. 8, a private localized sound bubble 78 is selectively created around the front seat occupant 56 while a separate private localized sound bubble 78′ has is selectively created around the front seat occupant 56′ while the private localized sound bubble 76 remains around the rear seat occupants 60 and 60′.

The private localized sound bubbles may be created around all of the individual seat occupants or, using the four seat occupants shown in FIGS. 7 and 8 as an example, may be created around two diagonally opposed seat occupants or around three seat occupants leaving one seat occupant with a private localized sound bubble or with no bubble at all.

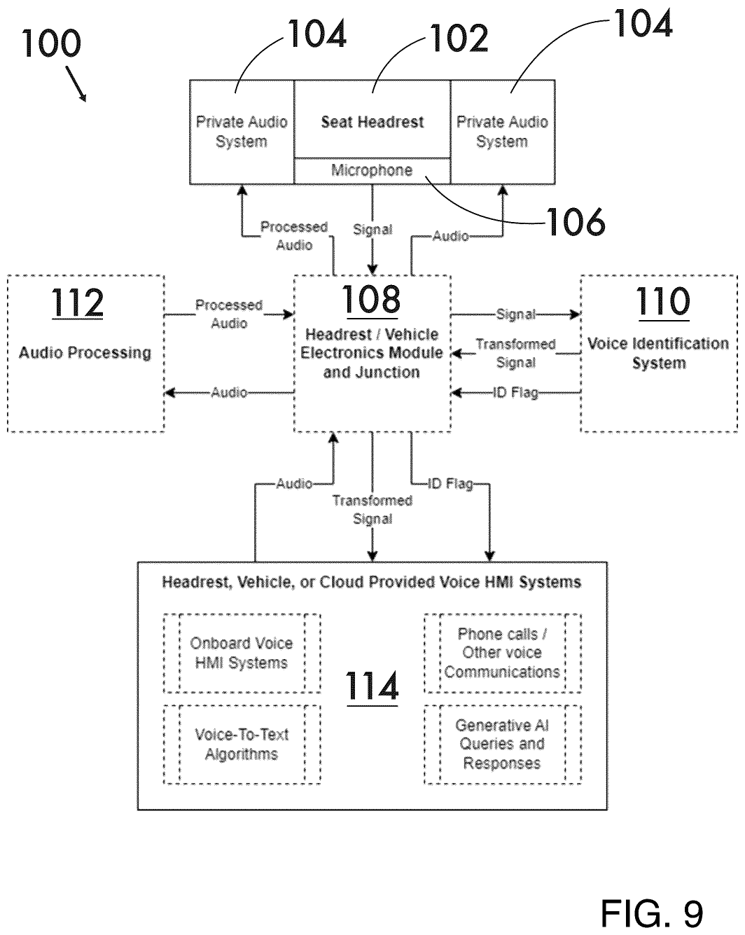

According to the first embodiment of the disclosed invention discussed above with respect to FIGS. 1 through 8 and as illustrated diagrammatically in FIG. 9 as seat occupant communication system 100 used primarily though not exclusively in conjunction with a vehicle seat illustrated above, a private voice interaction system 102 is fitted in the headrest of an automotive seat. Referring to FIG. 9, the system 102 includes a private audio system 104 which includes one or more microphones 106. It is to be understood that while one microphone 106 is illustrated in FIG. 9 the number and placement of the microphones may vary with, for example, one microphone 106 being positioned in a headrest with one or more other microphones (not shown) being strategically positioned elsewhere in the vehicle's interior as illustrated in FIG. 6 and as discussed in conjunction therewith. The private voice interaction system 102 may be used to detect the voice signal from the seat occupant within the private localized sound bubble.

The seat occupant communication system 100 further includes an electronics module and junction 108, a voice identification system 110, an audio processing system 112, and a headrest, vehicle, or cloud provided voice HMI system 114.

The electronics module and junction 108 transfers the signals from one sub system to another. Depending on the application this sub system can be installed either local or remote.

The voice identification system 110 is capable of ingesting a microphone signal which contains the voice signal from a primary speaker. The voice identification system 110 returns an ID flag which indicates who the primary speaker is and a transformed microphone signal which contains only the signal of the primary speaker.

The audio processing system 112 processes audio returned by the voice HMI systems to deliver optimal private audio signals to the user of the private voice interaction system 102.

The local or cloud provided voice HMI system 114 inject the processed voice signal from the speaker and returns content specific to the person's request. The location of these systems can be local or remote to the module 108.

The electronics module and junction 108, the voice identification system 110, and the audio processing system 112 are preferably installed locally with respect to the private voice interaction system 102. The voice HMI system 114 is preferably but not absolutely installed remotely from the voice interaction system 102 and may be situated either in the vehicle's ECU unit or in the cloud. The user of the system can prompt responses from various voice HMI systems. The input to these systems consists of ID-flagged and filtered audio signals from the user, which have already been processed by the voice identification system 110. Therefore, the voice HMI system 114 is capable of providing enhanced responses and features using the ID flag and filtered audio. The audio signals provided to the user in response to their queries can be played back to the user privately after being processed by the audio processing system 112.

The described system can offer unique and tailored experiences that, in addition to enhancing entertainment and quality of life in the vehicle, can improve safety by allowing the user to keep their hands on the steering wheel and their eyes on the road.

Referring to FIG. 10, a side view of the second embodiment of the disclosed invention for use in an airplane or train is illustrated. A side view of a seat generally illustrated as 150 is shown. The seat 150 includes a seat back 152 and a seat base 154. It is to be understood that the seat 150 is shown for illustrative purposes only. The shapes and sizes of the seat back 152 and the seat base 154 as illustrated are not intended as being limiting.

The seat 150 includes a head restraint 156 attached to the seat back 152, typically by a common back supporting structure 158. A pair of opposed armrests are conventionally fitted to the seat 150 of which one armrest, armrest 160, is illustrated.

A remote console 162 is provided, typically fitted to the ceiling of the airplane as illustrated in FIG. 10. However, it is to be understood that the remote console 162 may be attached to a different surface.

The system speakers may be situated in the remote console 162 or may be disposed at a different location including the seat 150. Similarly, the system microphone(s) may be disposed in the remote console 162 or in a different location including the seat 150. Thus, it may be understood that the second embodiment of the disclosed invention offers a wide variety of potential audio input and output variations.

According to the second embodiment of the disclosed invention as illustrated diagrammatically in FIG. 11 as seat occupant communication system 200 used in conjunction with any seating arrangement in which an overhead or remote-control unit is conventionally provided such as in an aircraft such as that illustrated as remote console 162 in FIG. 10 and discussed in conjunction therewith. Similar to the first embodiment of the disclosed invention, the seat occupant communication system 200 further includes a private voice interaction system 202 which includes a private audio system 204 and one or more microphones 206. The seat occupant communication system 200 further includes an electronics module and junction 208, a voice identification system 210, an audio processing system 212, and a headrest, vehicle, or cloud provided HMI system 214. The electronics module and junction 208, the voice identification system 210, and the audio processing system 212 are preferably also located in the area usually occupied by individual reading lights and air vents to ensure efficient processing of audio signals.

The local or cloud provided voice HMI system 214 operates from a location separate from the private voice interaction system 202, such as the airplane's onboard computer systems or through a cloud-based service (neither shown). This arrangement allows passengers to use voice commands to interact with the system. The input consists of audio signals from the passenger, which have been processed for noise reduction and carry an ID flag to personalize the interaction.

The local or cloud provided voice HMI system 214 processes the user's requests using the ID flag and filtered audio to provide specific and personalized responses. Audio feedback generated in response to user queries is conveyed to the passenger through speakers in the overhead unit, with processing by the audio processing system 212 to maintain privacy.

This arrangement illustrated in FIG. 11 and described herein provides passengers with the ability to control their in-flight experience using voice commands, accessing entertainment and information without manual interaction with the overhead controls. The arrangement also improves convenience as well as a cleaner, less tactile environment on the airplane. In another configuration, the system is set up with part of the private voice interaction system 202, the microphone 206, installed within the armrest of the seat.

The electronics module and junction 208 is also preferably situated within the armrest 160 or possibly beneath the seat base 154, where it can process the audio input locally before sending it to the more complex systems for response generation. The local or cloud provided voice HMI system 214, responsible for both processing voice commands and generating responses, is located remotely from component private voice interaction system 202. The system 202 could be integrated into the airplane's central control unit or connected to cloud services (neither shown), depending on the system design and intended functionality.

The output from the system, such as feedback or responses to the passenger's voice commands, is delivered through a speaker system located in either the remote console 162 or in the head restraint 156. When located in the head restraint 156, the audio is advantageously directed to the passenger's ears, reducing the volume required and minimizing the disturbance to others.

The disclosed system enables passengers to access a variety of services through voice interaction, such as adjusting seat settings, requesting information, or accessing entertainment, without having to physically engage with touchpoints, thereby simplifying the user experience. The use of an ID flag in the processed audio ensures that responses are personalized to the user's previous preferences and requests.

### Advantages of the Disclosed System

The advantages of the present system which incorporates voice capture, identification, and private audio playback system include, are several and include, but are not limited to, the following features.

Ergonomic Interaction: Placement of the microphone in the armrest allows passengers to speak naturally without straining or leaning towards the device, thus promoting comfort during use.

Privacy: Placement of the speaker system in the headrest directs sound to the user's ears, thereby reducing the broadcast range while helping maintain a quiet environment for all passengers.

Noise Reduction: The close proximity of the microphone to the user improves voice capture quality by reducing background noise, leading to more accurate voice recognition.

Ease of Use: Users can readily control various functions through voice commands, thus improving accessibility for all passengers, including those with compromised mobility or visual impairments.

Hygiene: By minimizing physical contact with surfaces, the system contributes to a more hygienic environment. This feature is especially beneficial in public transportation to reduce the spread of pathogens.

Personalization: By incorporating ID-flagged audio processing, the system can provide responses tailored to the individual user's settings or preferences, thereby enhancing user satisfaction.

Safety: In vehicles, this system would allow users to keep their focus on the road, as it minimizes distractions by eliminating the need to look away from the road to operate controls.

Efficiency: Voice-activated systems streamline the delivery of services and information, potentially reducing the workload on support staff and the need for physical materials like instruction manuals or entertainment devices.

Modularity: The disclosed system can be easily adapted to provide a versatile solution for passenger interaction in a broad array of environments including but not limited to different models of vehicles, buses, trains, aircraft, robotaxis, eVTOL, flying cars, sea gliders, marine vessels, amphibious vehicles, wheelchairs, gaming and entertainment mobility and mass transit terminal seating.+

The foregoing discussion discloses and describes an exemplary embodiment of the present invention. One skilled in the art will readily recognize from such discussion, and from the accompanying drawings that various changes, modifications and embodiments can be made therein without departing from the true spirit and fair scope of the invention.

What is claimed:

1. An integrated sound and voice interaction system for use in a vehicle, the system comprising:
a plurality of seats with each seat having a headrest attached thereto;
at least one speaker integrally mounted in each headrest;
at least one microphone integrally mounted in each headrest;
a voice human machine interface for recognizing and distinguishing between occupants' voices whereby individual and private localized sound bubbles are created for two or more seat occupants; and
a network connecting the speakers, the microphones, and the voice human machine interface.

2. The system of claim 1, wherein each of the seats further includes a seat back and wherein at least one speaker is integrally mounted in at least one seat back.

3. The system of claim 1, further including a headliner and wherein at least one microphone is integrally mounted to the headliner.

4. The system of claim 1, wherein the plurality of seats includes two adjacent seats and wherein a sound bubble may be formed between the two adjacent seats.

5. The system of claim 1, wherein the plurality of seats includes a front seat and a back seat and wherein a sound bubble may be formed between the front and back seats.

6. The system of claim 1, wherein the plurality of seats includes two front seats and at least one back seat and wherein a sound bubble may be formed between two or more of any of the front or back seats.

7. The system of claim 1, wherein the system further includes an electronics module and junction, a voice identification system, and an audio processing system integrated with the network.

8. The system of claim 1, further including a speaker identifier to identify a vehicle passenger as the primary speaker.

9. An integrated sound and voice interaction system for use in a vehicle, the system comprising:
a plurality of seats with each seat having a headrest attached thereto;
at least one speaker integrally mounted in each headrest;
at least one microphone integrally mounted in each headrest; and
a seat occupant communication system which includes a private voice interaction system, the voice system including at least one speaker and at least one microphone integrated with at least two of the headrests to form a private localized sound bubble, the voice system detecting the voice signal from the seat occupant within the private localized sound bubble.

10. The system of claim 9, further including an electronics module and junction, a voice identification system, an audio processing system, and a headrest, vehicle, or cloud provided voice human machine interface system.

11. The system of claim 10, further including sub systems and wherein the electronics module and junction transfers signals from one sub system to another.

12. The system of claim 11, wherein the one or more sub systems can be installed either locally with the vehicle or placed external of the vehicle.

13. The system of claim 10, wherein the electronics module and junction, the voice identification system, and the audio processing system are installed locally with respect to the private voice interaction system.

14. An integrated sound and voice interaction system for use in a vehicle, the system comprising:
a plurality of seats with each seat having a headrest attached thereto;
at least one speaker integrally mounted in each headrest;
at least one microphone integrally mounted in each headrest, the system further including a headliner and wherein at least one microphone is integrally mounted to the headliner;
a voice human machine interface for recognizing and distinguishing between occupants' voices whereby individual and private localized sound bubbles are created for two or more seat occupants; and
a network connecting the speakers, the microphones, and the voice human machine interface, wherein each of the seats further includes a seat back and wherein at least one speaker is integrally mounted in at least one seat back.

15. The system of claim 14, wherein the plurality of seats includes two adjacent seats and wherein a sound bubble may be formed between the two adjacent seats.

16. The system of claim 14, wherein the plurality of seats includes a front seat and a back seat and wherein a sound bubble may be formed between the front and back seats.

17. The system of claim 14, wherein the plurality of seats includes two front seats and at least one back seat and wherein a sound bubble may be formed between two or more of any of the front or back seats.

18. The system of claim 14, wherein the system further includes an electronics module and junction, a voice identification system, and an audio processing system integrated with the network.

19. The system of claim 14, further including a speaker identifier to identify a vehicle passenger as the primary speaker.

20. The system of claim 14, further including an electronics module and junction, a voice identification system, an audio processing system, and a headrest, vehicle, or cloud provided voice human machine interface system.
